(19) United States
(12) Patent Application Publication
(10) Pub. No.: US 2013/0133916 A1
(43) Pub. Date: May 30, 2013

(54) MODULAR ELECTRIC SWITCH BOXES

(71) Applicant: CRYSTAL MOUNTAIN MANUFACTURING INC., Langley (CA)

(72) Inventors: Jason COLQUHOUN, Langley (CA); Adrian VAN WIJK, Vancouver (CA)

(73) Assignee: CRYSTAL MOUNTAIN MANUFACTURING INC., Langley (CA)

(21) Appl. No.: 13/687,912

(22) Filed: Nov. 28, 2012

Related U.S. Application Data
(60) Provisional application No. 61/564,197, filed on Nov. 28, 2011.

(51) Int. Cl. H01H 9/02

(52) U.S. Cl. CPC H01H 9/02
USPC 174/53

(57) ABSTRACT

The invention relates to an electric switch box. The electric switch box is modular and comprises a housing, an electric inlet, a first electric outlet, a second electric outlet, a switching component disposed in the housing for conducting and switching electric power from the electric inlet to either the first or second electric outlet. The electric switch box also comprises a male connecting portion on a side of the housing, and a corresponding female connecting portion on an opposite side of the housing. When the male and female connecting portions are shaped and dimensioned to allow the male connecting portion to engage the female connecting portion of another electric switch box.

### CROSS REFERENCE TO RELATED APPLICATIONS

This application claims the benefit of priority of U.S. Provisional Patent Application No. 61/564,197 filed Nov. 28, 2011, which is incorporated herein by reference in its entirety.

### TECHNICAL FIELD

The present invention relates generally to electric switch boxes, and more specifically to electric switch boxes configured to be coupled with one another.

### BACKGROUND

Electric switch boxes are useful as they allow a single ballast (or another type of power source) to be used to run two separate lights or other types of electrical appliances. In some situations, there is a need to selectively connect a plurality of power sources to a plurality of pairs of lights. Some manufactures make electric switch boxes which are configured to connect a plurality of ballasts to run a plurality of pairs of lights. Examples of such multi-ballast boxes include the FLIPBOX™ LSM-12 (http://powerboxine.com/lsm12.html) and LSM-20 (http://powerboxinc.com/lsm20.html) manufactured by Powerbox Inc. and the LF-2, LF-4, LF6, LF-8, LF-10 and LF-20 (http://horticontrol.com/store.html) manufactured by Horti Control Inc.

The inventor has determined a need for electric switch boxes that can be rapidly coupled together to form a multi-unit set in accordance with the number of power sources needed to be accommodated.

### BRIEF DESCRIPTION OF DRAWINGS

In drawings which show non-limiting embodiments of the invention:

FIG. 1 is a front perspective view of an electric switch box according to an example embodiment of the invention.

FIG. 1A is an exploded view of the FIG. 1 electric switch box.

FIG. 2 is a rear perspective view of the FIG. 1 electric switch box.

FIG. 3 is a side perspective view of the FIG. 1 electric switch box.

FIG. 4 shows four units of the FIG. 1 electric switch box coupled together to form a multi-unit set.

FIG. 5A is a schematic cross-sectional view of an electric switch box according to an example embodiment of the invention.

FIG. 5B is a schematic cross-sectional view of two of the FIG. 5A electric switch boxes coupled together. The broken line illustrates a switching component disposed inside the electric switch box.

FIG. 6A is a schematic cross-sectional view of an electric switch box according to an example embodiment of the invention.

FIG. 6B is a schematic cross-sectional view of two of the FIG. 6A electric switch boxes coupled together.

FIG. 7A is a schematic cross-sectional view of an electric switch box according to an example embodiment of the invention.

FIG. 7B is a schematic cross-sectional view of two of the FIG. 7A electric switch boxes coupled together.

FIG. 7C is a schematic cross-sectional view of four of the FIG. 7A electric switch boxes coupled together.

FIG. 8 shows a pair of coupled electric switch boxes in combination with ballasts, power supplies and a timer used together to power a first set of lights.

FIG. 9 is similar to FIG. 8 and shows a pair of coupled electric switch boxes in combination with ballasts, power supplies and a timer used together to power a second set of lights.

FIGS. 10A and 10B are perspective views of an electric switch box according to another embodiment of the invention.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

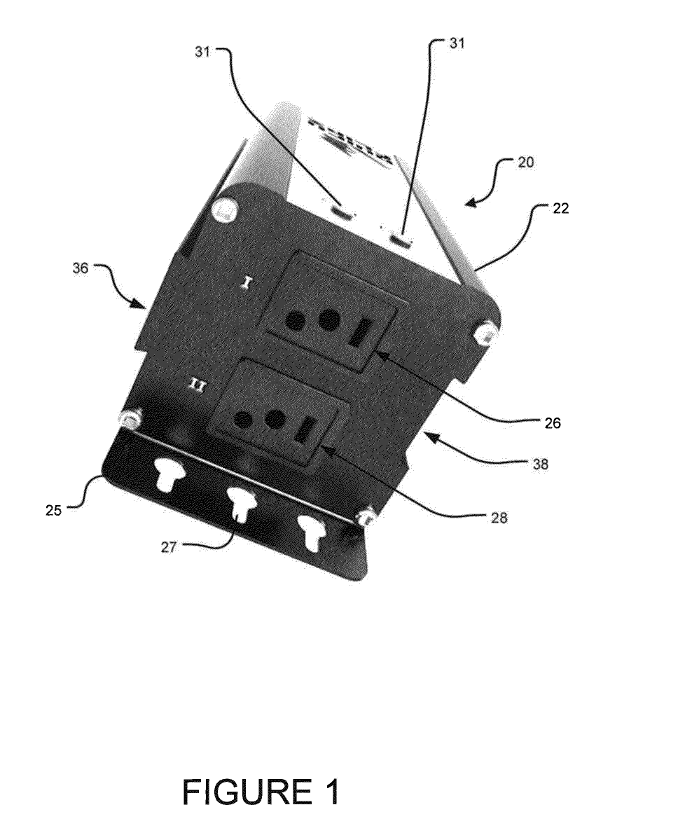

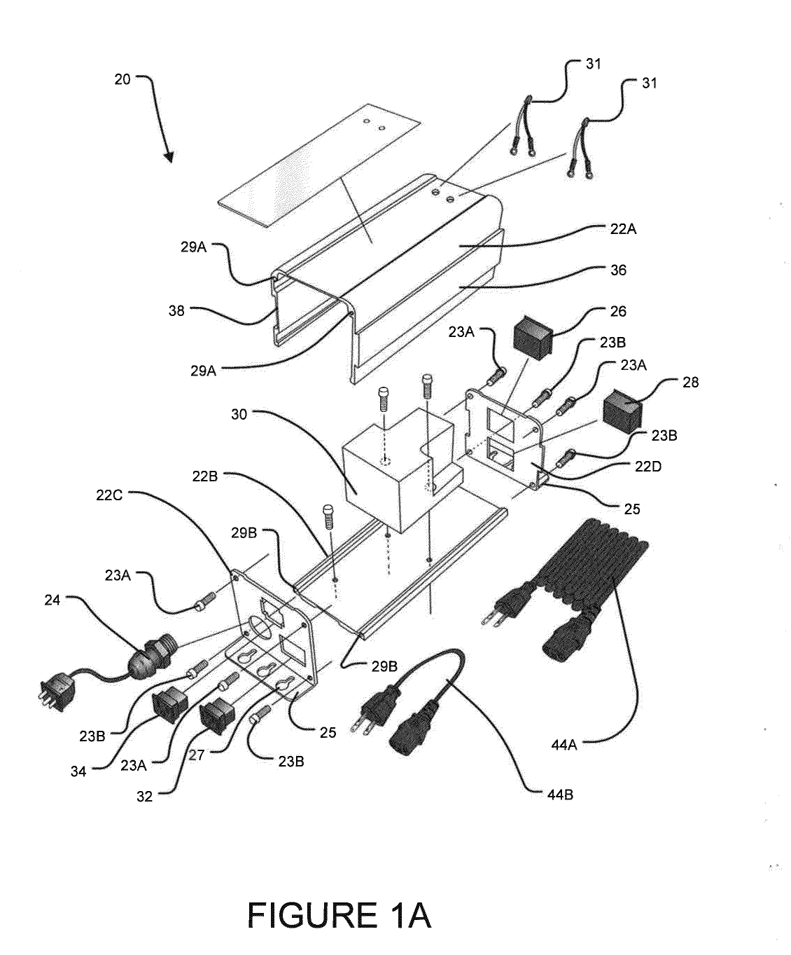

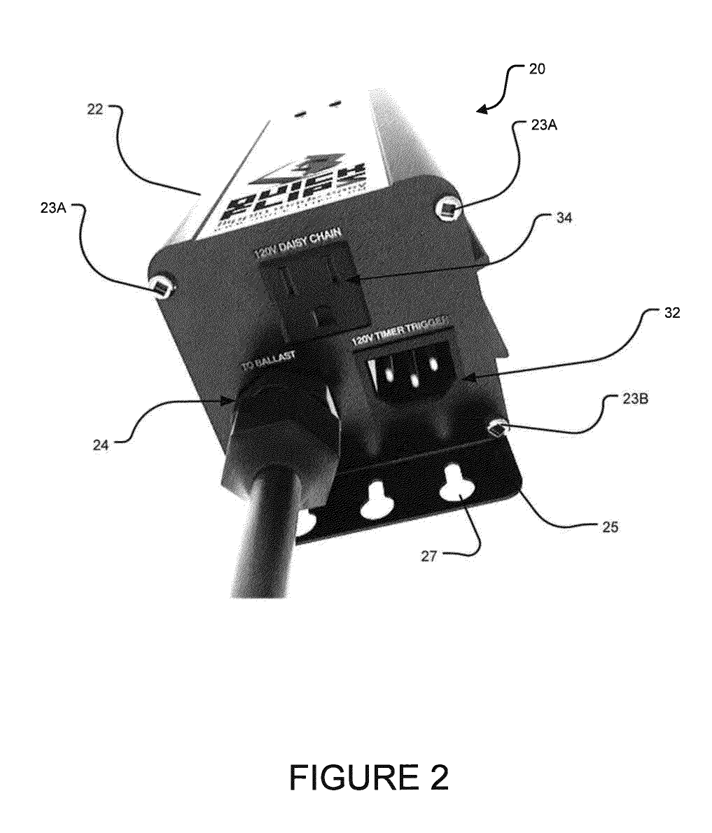

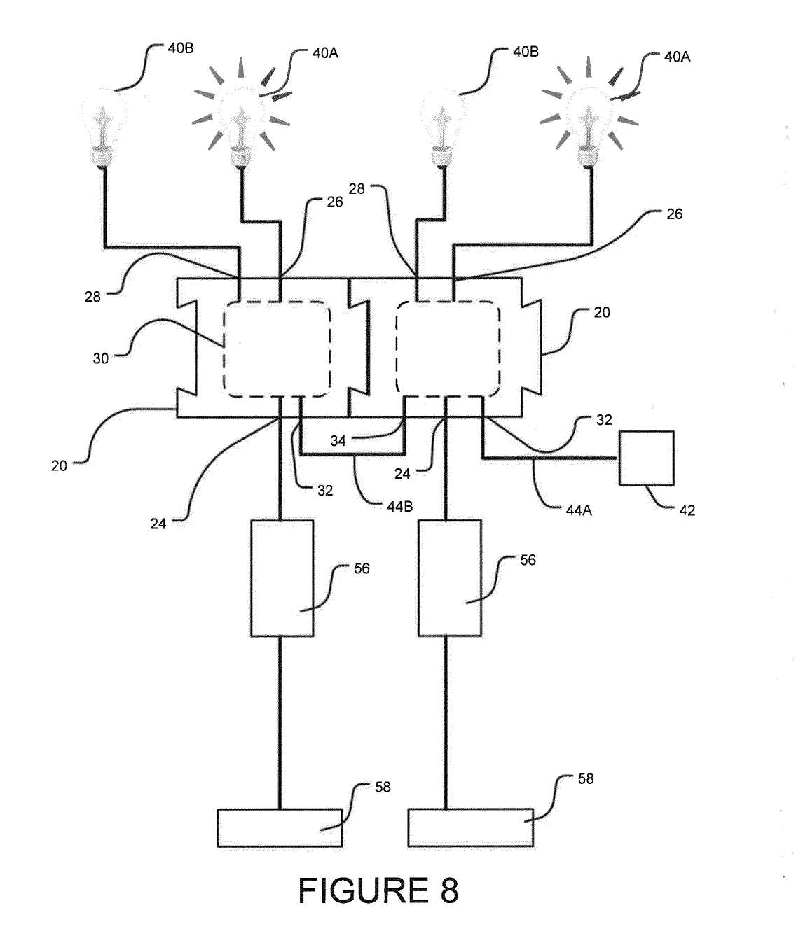

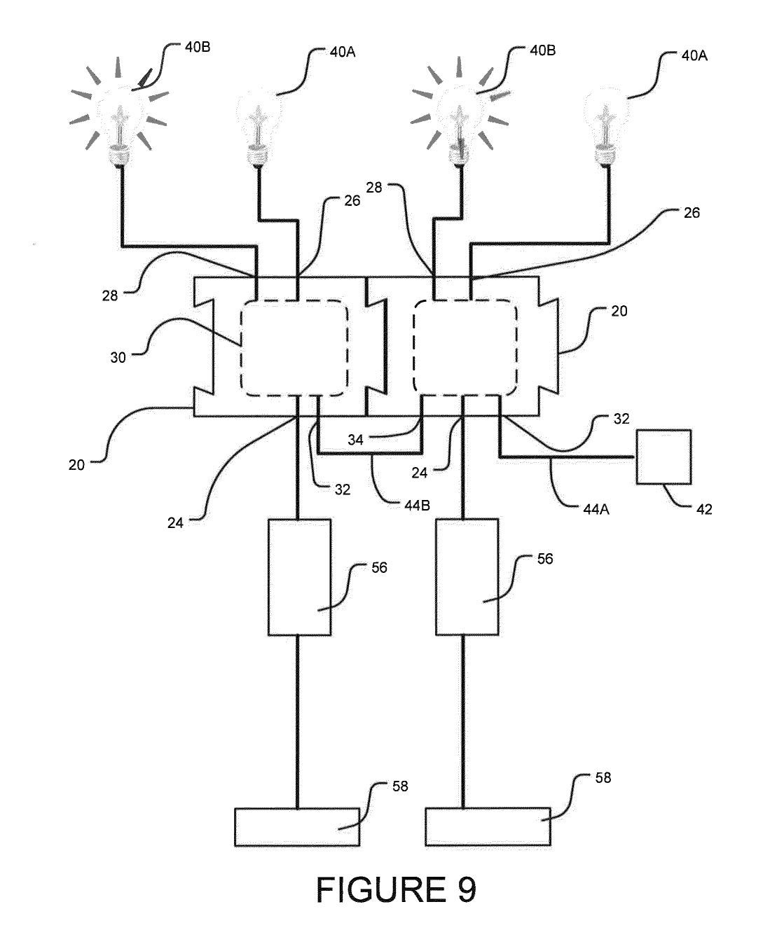

An electric switch box 20 according to an example embodiment of the invention is shown in FIGS. 1-4. Electric switch box 20 comprises a housing 22 containing a switching component 30 as described below. Electric switch box 20 also comprises an electric inlet 24 for connecting electric switch box 20 to a ballast 56 and/or a power supply 58 (schematically illustrated in FIGS. 8 and 9), a first electric outlet 26 and a second electric outlet 28 each of which for connecting electric switch box 20 to a light or other electrical appliance. In the FIGS. 1-4 embodiment, inlet 24 is located on a “rear” end of housing 22, and outlets 26, 28 are located on a “front” end of housing 22.

As best seen in FIG. 1A, in an example embodiment housing 22 comprises a cover 22A, a base 22B, a rear end plate 22C and a front end plate 22D. Cover 22A has complementary male and female connecting portions 36 and 38 on opposed sides thereof, to facilitate rapid and secure coupling to other switch boxes 20 as discussed further below. The “tops” of end plates 22C and 22D are coupled to cover 22A by bolts 23A received in threaded apertures 29A in cover 22A. The “bottoms” of end plates 22C and 22D are coupled to base 22B by bolts 23B received in threaded apertures 29B in base 22B. FIG. 1A also shows a long timer cord 44A for connecting a timer cord inlet 32 to an external timing device and a short timer cord 44B for connecting a timer cord outlet 34 to the timer cord inlet of another switch box 20, as discussed further below with reference to FIG. 8 and FIG. 9. The wiring connecting the switching component 30 to power inlet 24, power outlets 26, 28, timer cord inlet 32 and timer cord outlet 34 is not shown in FIG. 1A.

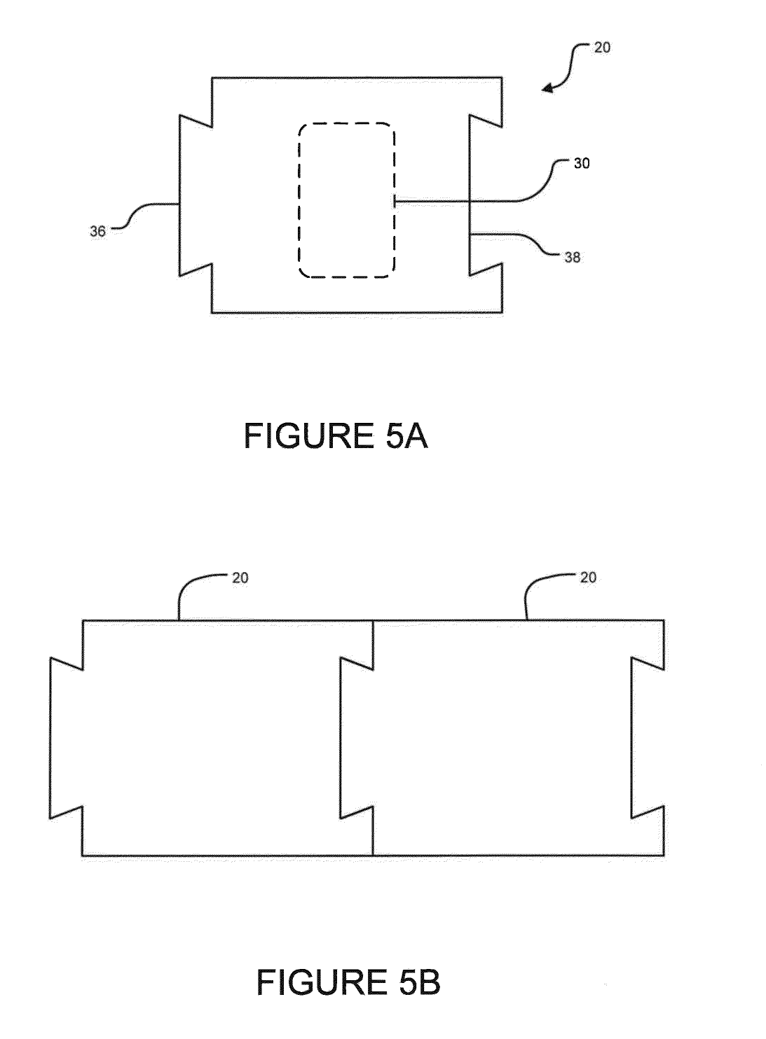

Electric switch box 20 comprises a switching component 30 which is capable of conducting and switching electric power from inlet 24 to either one of outlets 26, 28 as known in the art. An indicator 31 (which may comprise, for example, an LED) is coupled to each of outlets 26, 28 to indicate whether the respective outlet is being provided with power from switching component 30. The operation of the switching component 30 may be controlled by a timer, as described below. The switching component 30 is located inside housing 22 and is schematically illustrated in FIG. 1A and with broken lines in FIG. 5A, FIG. 8 and FIG. 9. Electric switch box 20 thus allows a single ballast or a single power supply to run two separate lights or two separate electrical appliances, one at a time, by switching electric power back and forth between first outlet 26 and second outlet 28.

Electric switch box 20 may comprise a timer cord inlet 32 for connecting electric switch box 20 to an external timing device (e.g. timer 42) via a timer cord 44 (schematically illustrated in FIGS. 8 and 9). When electric switch box 20 is connected to the external timing device, the external timing device can manually or automatically switch electric switch box 20 between the two electric outlets 26, 28 at an interval specified by the user (e.g., every 12 hours). Instead of an external timing device, it is also possible for electric switch box 20 to have a built-in timing device (not shown). Electric switch box 20 may further comprise a timer cord outlet 34 for daisy-chaining two or more electric switch boxes 20 together by connecting a timer cord 44 from the timer cord outlet 34 of one electric switch box to the timer cord inlet 32 of another electric switch box and repeating the process until all the electric switch boxes are connected in a daisy chain. This way, a single external timing device could be used to control two or more electric switch boxes 20 when these electric switch boxes 20 are daisy-chained. This is schematically shown in FIGS. 8 and 9.

Housing 22 of electric switch box 20 may be provided with a flange 25 at each end thereof. As best seen in FIG. 1A, flanges 25 may be formed by bent portions of end plates 22C and 22D. Each flange 25 may comprise one or more apertures 27 for securing electric switch box 20 to a building structure (e.g., a wall) via fasteners (e.g., screws).

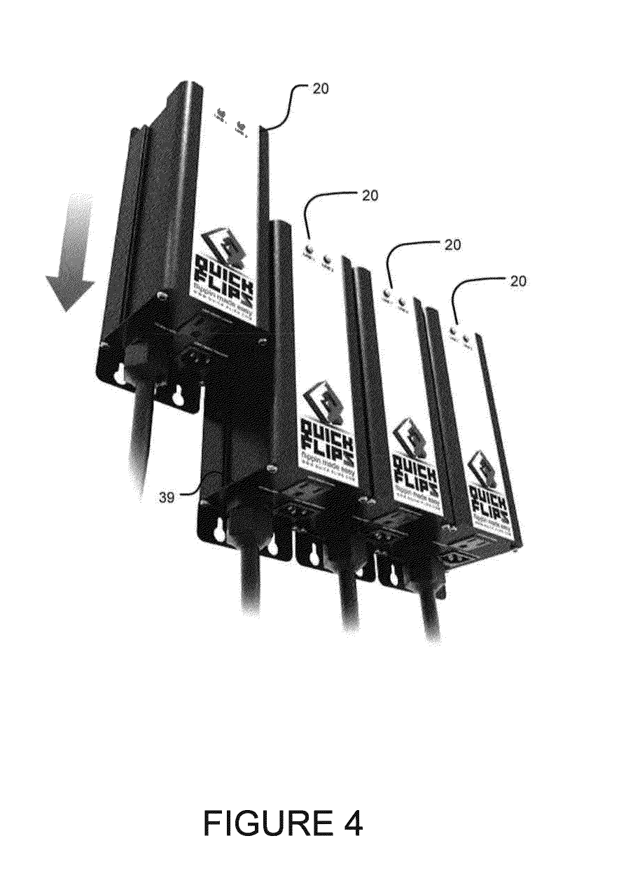

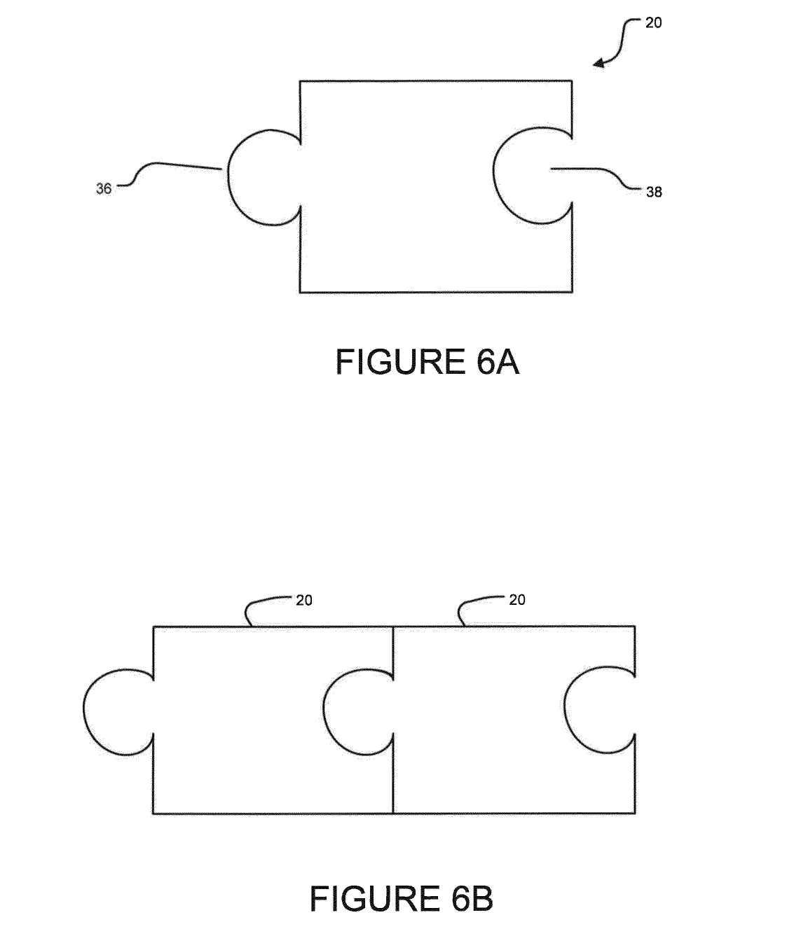

Housing 22 of electric switch box 20 may be provided with a male connecting portion 36 and/or a female connecting portion 38. In the illustrated example embodiments, electric switch box 20 comprises both male and female connecting portions 36, 38. In other embodiments, electric switch box 20 may comprise only male connecting portion 36, or only female connecting portion 38. Connecting portions 36, 38 may be located on opposite sides of housing 22. Preferably, connecting portions 36, 38 are located on opposed longitudinal sides of housing 22 so they do not interfere with electric inlet 24 or electric outlet 26, 28. Some example embodiments of male and female connecting portions 36, 38 are schematically shown in FIGS. 5A, 6A, and 7A in cross-sectional views. Female connecting portion 38 comprises a concavity shaped and dimensioned to snugly receive male connecting portion 36. Thus, male and female connecting portions 36, 38 allow two adjacent electric switch boxes 20 to be coupled together by sliding male connecting portion 36 of one box 20 into female connecting portion 38 of another box 20. FIG. 4 shows three electric switch boxes 20 already coupled together and a fourth electric switch box 20 in the process of being slidably coupled to the other electric switch boxes.

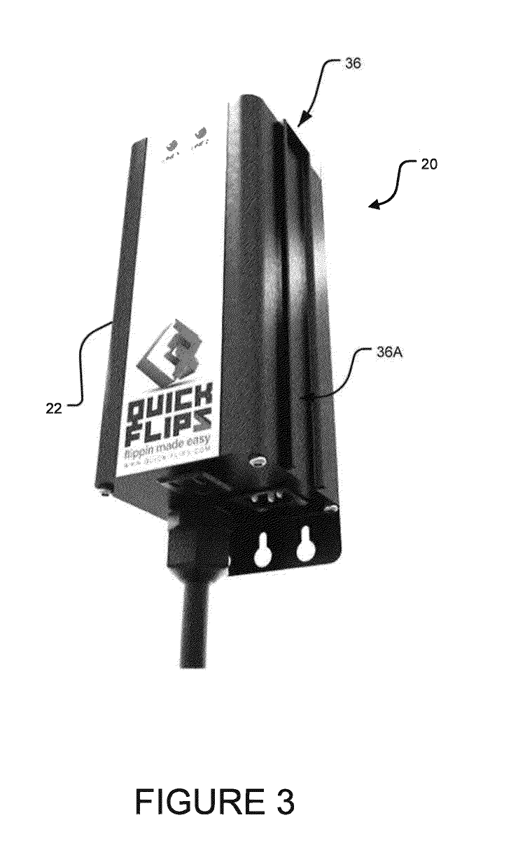

As shown in FIGS. 1-4, female connecting portions 38 may be in the form of a groove. Such groove may have a generally dove-tailed cross-section. Such groove may extend the entire or partial longitudinal length of electric switch box 20. Male connecting portions 36 may be in the form of an elongated protrusion. Such protrusion may also have a generally dove-tailed cross-section. Such protrusion may be substantially solid, as shown for example in FIG. 1A, or may have an open center portion 36A as shown in FIG. 3 so as to form a channel between an adjacent switch box 20 as discussed below. Such protrusion may extend the entire or partial longitudinal length of electric switch box 20. In the FIG. 4 embodiment, male and female connecting portions 36, 38 extend the entire longitudinal length of electric switch box 20, and the lower end of female connecting portion 38 has a stop member 39. Stop member 39 may be provided by rear end plate 22C as in the illustrated example, or alternatively may be provided by front end plate 22D or at one end of cover 22A. With stop member 39, it is possible to secure a plurality of electric switch boxes 20 to a building structure (e.g., a wall) without screws or other fasteners for each box by orienting the boxes such that stop members 39 are at the bottoms thereof, such that male connecting portions 36 are prevented from sliding out of the bottom ends of female connecting portions 38 by stop members 39.

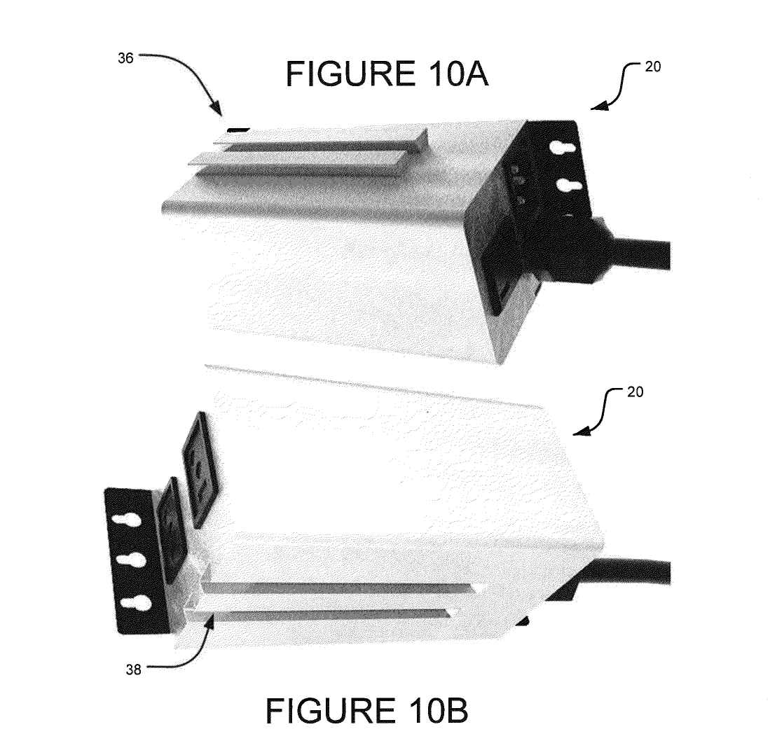

FIGS. 10A and 10B show an embodiment of electric switch box 20 having female and male connecting portions respectively in the form two grooves and two corresponding elongate protrusions which extend partially along opposite longitudinal sides. By having male and female connecting portions 36, 38 only part way down the sides of the box, it is also possible to secure a plurality of electric switch boxes 20 to a building structure (e.g., a wall) without screws or other fasteners for each box, since with the boxes oriented such that male and female connecting portions 36, 38 extend only part way down from the tops of the boxes, the bottoms end of male connecting portions 36 abut the bottom ends of female connecting portions 38.

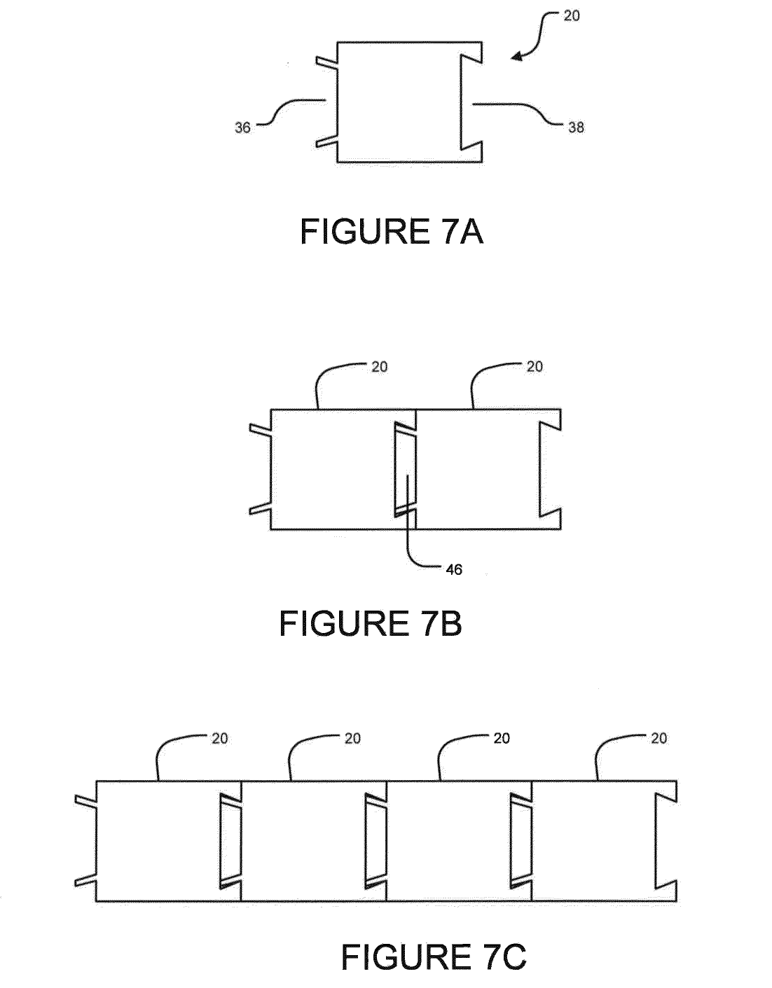

In the FIG. 7A embodiment, male connecting portion 38 comprises a pair of elongate protrusions spaced apart by a concavity. When a pair of electric switch boxes 20 according to the FIG. 7A embodiment are coupled together, they define a channel 46. Channel 46 may be advantageous in some applications because it provides improved air flow for heat ventilation. A similar channel may be formed by the open center portion 36A as shown in FIG. 3.

In some embodiments, the coupling between male and female connecting portions 36, 38 may provide a “snap lock” coupling wherein one or both of male and female connecting portions 36, 38 is deformed during coupling and restorative deformative forces which tend to restore the shape of connecting portions 36, 38 snap connecting portions 36, 38 into a locked coupling configuration with one another. In such embodiments, the portions of housing 22 forming connecting portions 36, 38 are made from a resiliently deformable material.

FIGS. 8 and 9 illustrate the operation of two electric switch boxes 20 in combination with other components in an example implementation. In the illustrated example, two electric switch boxes 20 are coupled together. It should be apparent that more than two electric switch boxes may also be coupled together to form a multi-unit set. It should also be apparent that each electric switch box 20 may be used individually without being coupled to another electric switch box 20. The electric inlet 24 of each electric switch box 20 is connected via a cord to a ballast 56 which is in turn connected to a power supply 58. In some situations, a user may connect the electric inlet 24 of each electric switch box 20 directly to power supply 58 without the intervening ballast 56. Two sets of lights 40A and 40B (or other electric appliances) are connected to electric switch boxes 20. One set of lights 40A are connected to first outlets 26 and another set of lights 40B are connected to second outlets 28. The first electric switch box 20 is connected to a timer 42 via a timer cord 44A (which extends from the timer cord inlet 32 of the first electric switch box 20 to timer 42). Another timer cord 44B is connected between the timer cord outlet 34 of the first electric switch box 20 and the timer cord inlet 32 of the second electric switch box 20. If more than two electric switch boxes 20 are used, this step may be repeated until all the electric switch boxes 20 are daisy-chained. Once the set-up is completed, the electric switch boxes 20 will switch electric power between the first set of lights 40A and second sets of lights 40B at a specified time interval as set by timer 42, or as otherwise specified by the user.

The electric switch boxes 20 disclosed herein have many advantages. They can be easily coupled together to form a multi-unit set in accordance with the number of electric switch boxes a user requires. If the user needs exactly five electric switch boxes, he can make a five-unit set. If the user needs exactly eleven electric switch boxes, he can make an eleven-unit set. This eliminates the need for custom-made multi-unit sets which typically have a fixed number of electric outlets and inlets. They can also be easily decoupled if one unit requires maintenance or replacement. The modular feature also allows electric switch boxes 20 to be easily coupled together during storage or shipping, thereby saving shelf or shipping space. The coupling feature also make electric switch boxes 20 to be more securely engaged to one another when they are in use and individual units do not easily fall off when they are in use.

The electric switch boxes 20 of the present invention also provide an advantage to manufacturers. Due to the modular feature of electric switch boxes 20, a manufacturer only needs to test a single product and seek approval and certification for that single product from regulatory bodies (e.g., Canadian Standards Association). In contrast, manufacturers of fixed multi-unit switch boxes may need to test and get approval and certification for the multiple types of products.

As will be apparent to those skilled in the art in the light of the foregoing disclosure, many alterations and modifications are possible.

The above-described embodiments are intended to be examples only. Alterations, modifications and variations can be effected to the particular embodiments by those of skill in the art without departing from the scope, which is defined solely by the claims appended hereto.

What is claimed is:

1. An electric switch box comprising:
a housing;
an electric inlet;
a first electric outlet;
a second electric outlet;
a switching component disposed in the housing for conducting and switching electric power from the electric inlet to either the first or second electric outlet;
a male connecting portion on a side of the housing;
a female connecting portion on an opposite side of the housing;
wherein the male and female connecting portions are correspondingly shaped and dimensioned to allow the male connecting portion to engage the female connecting portion of another electric switch box.

2. The electric switch box of claim 1, wherein the female connecting portion comprises a dovetail-shaped groove.

3. The electric switch box of claim 2, wherein the male connecting portion comprises a dovetail-shaped protrusion.

4. The electric switch box of claim 3 wherein the dovetail-shaped protrusion has an open center portion.

5. The electric switch box of claim 1, wherein the male connecting portion comprises two spaced-apart longitudinal bars extending away from a surface of the housing.

6. The electric switch box of claim 1, wherein the male and female connecting portions are configured such that wherein when a pair of the electric switch boxes are coupled together, the male and female connecting portions define a channel between the pair of coupled electric switch boxes.

7. The electric switch box of claim 1, wherein the one or both of the male and female connecting portions provide a snap-lock coupling wherein, during the formation of the snap-lock coupling, one or both of the male and female connecting portions is first deformed and then restored at least partially toward its original shape and into a locked coupling configuration by restorative deformation forces.

8. The electric switch box of claim 1, wherein the electric switch box comprises two or more male connecting portions and two or more corresponding female connecting portions.

9. The electric switch box of claim 1, further comprising a timer cord inlet for connecting the electric switch box to an external timer.

10. The electric switch box of claim 9, further comprising a timer cord outlet, wherein the timer cord inlet and the timer cord outlet allow a plurality of electric switch boxes to be daisy-chained and under the control of the external timer.

11. The electric switch box of claim 1, further comprising a built-in timer.

12. The electric switch box of claim 1 wherein the male and female connecting portions extend from one end of the housing part way along opposed longitudinal sides of the housing.

13. The electric switch box claim 1, wherein the male and female connecting portions extend substantially all the way along opposed longitudinal sides of the housing.

14. The electric switch box of claim 13, comprising a stop member at one end of the female connecting portion.

15. The electric switch box of claim 1, wherein the housing comprises a cover having the male and female connecting portions formed thereon, a base, and a pair of opposed end plates connected to opposite ends of the cover and the base.

16. The electric switch box of claim 15, wherein each end plate comprises a bent portion forming a flange, each flange being generally co-planar with an outer surface of the base.

17. The electric switch box of claim 16, wherein each flange has a plurality of apertures therein for securing the electric switch box to a support structure.
